(19) United States
(12) Patent Application Publication
(10) Pub. No.: US 2012/0239444 A1
(43) Pub. Date: Sep. 20, 2012

(54) MVT OPTIMIZATION OF BUSINESS PROCESS MODELING AND MANAGEMENT

(75) Inventor: Murray Todd Williams, New York, NY (US)

(73) Assignee: Accenture Global Services Limited, Dublin (IE)

(21) Appl. No.: 13/047,985

(22) Filed: Mar. 15, 2011

(51) Int. Cl. G06Q 10/00

(52) U.S. Cl. 705/7.11

(57) ABSTRACT

A multivariate business process modeling or management (BPM) optimization system and method for optimizing a BPM system includes a logic layer to control operation of the BPM system, a utility layer to implement a randomized experimental treatment based on a hypothesis, and a persistence layer to collect data from application of the randomized experimental treatment to the BPM system. The multivariate BPM optimization system and method optimizes the BPM system by computerized testing of the hypothesis and generation of results to add, remove or modify a step or modify a point in a flow of the BPM system based on the data collected from application of the randomized experimental treatment.

### BACKGROUND

Service Oriented Architecture (SOA) refers to a set of design principles that, when applied to a computer architecture, creates a system that is built out of smaller pieces (services) that can be easily reconfigured and reused. In the context of a corporation's IT infrastructure, SOA can refer to the various systems, such as web sites, personnel databases, product databases, inventory systems, accounting systems, etc., that are built as interchangeable elements. In this SOA context, business process modeling or management (BPM) is the “wiring” of individual services into a composite system. BPM software can allow users (e.g. business analysts) to model different possible systems, and system developers to implement the models into large, automated systems that act as new software applications. These models can include actual individuals that perform predetermined tasks.

Currently BPM process optimization is performed using an iterative process in which the existing process is modeled, for example, by creating mathematical predictions as to the costs and benefits of each sub-process and, using these predictions, an examination is made of whether a new BPM methodology would theoretically improve the system. That is, the same mathematical assumptions would be applied logically to decide whether an improvement would be realized, and thus BPM process optimization is reduced to a thought experiment. Once the model is implemented, it can be validated by confirming if the actual improvements match the predicted model. An example of a BPM process includes automation of a home mortgage application review and approval process, which generally involves computer systems and human agents for facilitating the processing of mortgage applications. In such a home mortgage application review and approval process, current techniques of BPM process optimization may include re-modeling of the process by including, removing or modifying one or more processes based on, for example, customer feedback or industry research.

Current BPM process optimization however does not use methods associated with statistical experiments. The modeling approach does not provide for the use of live experimentation, hypothesis testing and statistically significant results to be used for gain/loss predictions (e.g. coming up with predictive estimates as to what the actual possible loss or gain is of an alternative business process), or confidence intervals. Moreover, the modeling approach also does not provide for a scientific approach for determining optimum settings.

### SUMMARY OF THE INVENTION

A multivariate business process modeling or management (BPM) optimization system for optimizing a BPM system may include a logic layer to control operation of the BPM system, a utility layer including software executed by a computer system to implement a randomized experimental treatment based on a hypothesis, and a persistence layer to collect data from application of the randomized experimental treatment to the BPM system. The multivariate BPM optimization system may optimize the BPM system by computerized testing of the hypothesis and generation of results to add, remove or modify a step or modify a point in a flow of the BPM system based on the data collected from application of the randomized experimental treatment.

For the multivariate BPM optimization system described above, the logic layer may include an experiment transmitter service to modify or replace an existing service, and thus integrate the BPM optimization system with the BPM system or a BPM sub-system. The logic layer may also include a delegator service to map a specific BPM application to an appropriate account and configuration in the BPM optimization system, and thus associate the BPM system or the BPM sub-system with an experimental treatment in the BPM optimization system. The logic layer may further include a segment manager service to manage all incoming segmentation variables that identify test subject qualifications, and thus define experimental segments based on the data collected from application of the randomized experimental treatment.

For the multivariate BPM optimization system described above, the utility layer may include a treatment provider service to assign the randomized experimental treatment based on a particular set of attribute name/value pairs, and thus create the randomized experimental treatment based on a particular attribute. The utility layer may also include an identity provider service to manage the unique identification of experimental test subjects, and thus manage reference keys used by an instance cache service, a history archive service, or external BPM data systems to uniquely identify experimental test subjects. The utility layer may further include an outcome recorder service to store individual experimental test results, and thus manage delivery and storage of experimental outcomes.

For the multivariate BPM optimization system described above, the persistence layer may include a log service to record events associated with the BPM system. The persistence layer may also include an instance cache service to store treatment, identity and segmentation data for accessibility. The persistence layer may further include a history service to store outcome data, and thus store the data collected from application of the randomized experimental treatment.

For the multivariate BPM optimization system described above, the logic, utility and persistence layers may enable customization and adaptation of the multivariate BPM optimization system to the BPM system. The randomized experimental treatment may include an assignment of levels of attributes in a statistical experimental design. An example of levels of attributes may refer to specific settings of a parameter in a BPM system. Different levels of attributes may also refer to entirely different variations of sub-process in a BPM system. Thus, the randomized experimental treatment may include a variation in a process in the BPM system. The multivariate BPM optimization system may further include an adaptive process to indicate if the randomized experimental treatment is suboptimal prior to completion of a statistical experiment. The foregoing results may be automatically generated statistically significant results for gain and loss predictions based on modification of the BPM system. Alternatively, the results may be automatically generated statistically significant results for determination of significance of contribution of a particular attribute of the randomized experimental treatment. Yet further, the results may be automatically generated statistically significant results for determination of an interaction between different processes of an optimized BPM system or the BPM system.

According to an embodiment, a method performs optimization of a business process modeling or management (BPM) system. The method may include identifying a location in the BPM system to test, and defining a randomized experimental treatment based on a hypothesis for the identified location, and applying the randomized experimental treatment to the BPM system. The method may further include optimizing the BPM system by computerized testing of the hypothesis and generating results, and adding, removing or modifying a step or modifying a point in a flow of the BPM system based on data collected from application of the randomized experimental treatment.

For the method described above, the method may further include defining attributes of the randomized experimental treatment and assigning levels of the attributes in a statistical experimental design. Attributes may also be referred to as independent variables in terms of statistical modeling. The method may also include modifying a process or relative flow of a process in the BPM system for the randomized experimental treatment. The method may also include automatically indicating if a randomized experimental treatment is suboptimal prior to completion of a statistical experiment. For the foregoing method, the results may be automatically generated statistically significant results for determining significance of contribution of a particular attribute of the randomized experimental treatment. Alternatively, the results may be automatically generated statistically significant results for determining an interaction between different processes of an optimized BPM system or the BPM system.

According to an embodiment, a non-transitory computer readable medium having stored thereon a computer executable program to optimize a business process modeling or management (BPM) system is provided. The computer executable program when executed may cause a computer system to identify a location in the BPM system to test, and define a randomized experimental treatment based on a hypothesis for the identified location, and apply the randomized experimental treatment to the BPM system. The computer executable program when executed may further cause the computer system to optimize the BPM system by testing the hypothesis and generating results, and add, remove or modify a step or modify a point in a flow of the BPM system based on data collected from application of the randomized experimental treatment.

For the computer readable medium described above, the computer executable program when executed may further cause the computer system to define attributes of the randomized experimental treatment and assign levels of the attributes in a statistical experimental design. The computer executable program when executed may further cause the computer system to vary a process or relative flow of a process in the BPM system for the randomized experimental treatment.

### BRIEF DESCRIPTION OF DRAWINGS

The embodiments of the invention will be described in detail in the following description with reference to the following figures.

FIG. 1 illustrates a system diagram for a multivariate BPM optimization system, according to an embodiment;

FIG. 2 illustrates an additional system diagram for a multivariate BPM optimization system, according to an embodiment;

FIG. 3 illustrates a method for performing multivariate BPM optimization, according to an embodiment; and

FIG. 4 illustrates a computer system, according to an embodiment.

### DETAILED DESCRIPTION OF EMBODIMENTS

For simplicity and illustrative purposes, the principles of the embodiments are described by referring mainly to examples thereof. Also, the embodiments may be used in combination with each other. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments. Also, the embodiments described herein may be used with each other in various combinations.

### 1. Overview

According to an embodiment, a multivariate BPM optimization system (MVT BPM optimization system) is provided for applying statistical experimental design to business processes (also referred to as business systems herein) with the goal of optimizing specific target metrics such as cost, efficiency, customer satisfaction, profit or other business goals. The MVT BPM optimization system thus provides for adjustment or modification of a BPM process (for example, modification of a business process flow, which can be specified in a flow chart format), where a BPM process (also referred to as BPM system herein) is an orchestration engine that decides the order in which pieces of a business process are supposed to be engaged. The multivariate testing/optimization for SOA Orchestration/BPM solutions includes, but are not limited to, CRM (customer relationship management) and ERP (enterprise resource planning) domains. Generally, any SOA service composition can be a candidate for optimization using the MVT BPM optimization system, where BPM systems can be used to compose, orchestrate or piece-together service compositions.

The statistical experimental design applied by the MVT BPM optimization system may include assigning an experimental treatment at a predetermined location in an existing BPM process. An experimental treatment is a particular assignment of levels of attributes (e.g. independent variables) in the statistical experimental design, or a variation in any process or relative flow of a particular process in an existing BPM process. Thus a treatment is a collection of one randomly assigned level for each one of the attributes in an experiment, or in other words, a random assignment of randomly decided levels for all of the attributes in an experiment. A level is one possible setting for an attribute, where an attribute is a single variable in the experimental treatment. Further, multivariate testing is the testing of multiple hypothesis at once. Thus the MVT BPM optimization system enables determination of improvement in a BPM process based on the simultaneous testing or manipulation of multiple processes.

In an example related to a BPM process for a mortgage application review and approval process (see discussion in Section 4—Example), the statistical experimental design may include the attributes of credit-score cut-off level, or the length of time a loan officer has been with a company. The credit-score cut-off level attribute may include any level chosen by a user (e.g. 500, 600, 700 etc.), and the length of time a loan officer has been with a company attribute may likewise include any level chosen by a user (e.g. 6 months, 1 year etc.). In the foregoing mortgage application example, an example of an experimental treatment may be a credit-score cut-off level of 500, and a length of time a loan officer has been with a company of 6 months. Another example of an experimental treatment may be a credit-score cut-off level of 700, and a length of time a loan officer has been with a company of 1 year.

The MVT BPM optimization system creates a valid statistical multivariate experiment that can apply alternative algorithms, track results, determine optimal levels, and automatically adapt business processes. The MVT BPM optimization system uses existing BPM software (orchestration and rules engines) to control an experiment and record outcomes, and uses statistical practices to drive the entire process. The MVT BPM optimization system uses live data to create real statistical estimates, as opposed to analysis being dependent on (possibly erroneous) simulation assumptions. MVT methodology allows optimization of multiple components simultaneously, the software automation reduces human effort, and the MVT BPM optimization system creates actual statistical estimates of optimal levels and expected performance/cost/benefit gains.

Thus the MVT BPM optimization system provides for estimates of the necessary sample size for statistical significance in conclusions, statistically significant conclusions to hypothesis, and actual estimates with specific confidence intervals over probable gains or losses. The MVT BPM optimization system also enables inclusion of advanced techniques that “continuously adapt” the experiment so that early gains can be rapidly incorporated.

The MVT BPM optimization system can be applied to a variety of industries, for example, banking, health care, manufacturing, government etc., wherever a business process can be implemented. Examples of applications of the MVT BPM optimization system will be described herein with reference to automation of a home mortgage application review and approval process.

### 2. System

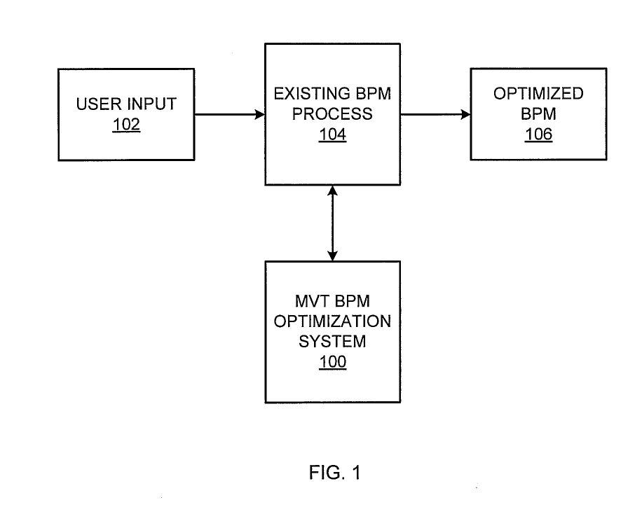

FIG. 1 illustrates a high-level diagram of a MVT BPM optimization system 100, according to an embodiment. Generally, a user (e.g. a business analyst) at 102 would input or load their existing BPM process 104 and would utilize MVT BPM optimization system 100, for example, by creating a new node in the existing BPM process (e.g. in the BPM flow diagram) driven by MVT BPM optimization system 100. The services provided by MVT BPM optimization system 100 may be new services, and may be incorporated as a splitter in the existing flow diagram for the user's existing BPM process. As discussed in further detail below, the user may create a new experiment and define its attributes in MVT BPM optimization system 100. With the experiment and attributes defined, MVT BPM optimization system 100 may be part of the user's existing BPM orchestration. The BPM orchestration may be modified by adding a new service associated with a particular attribute of the experiment, and based on the level of that attribute, the flow of the modified/optimized BPM process 106 may be directed to one or more new or different paths in the overall BPM process (e.g. new or different paths in the overall BPM flow diagram).

MVT BPM optimization system 100 thus provides a platform that allows a user (e.g. a business analyst) to define an experiment to actually control existing BPM process 104 in order to create variations and track their outcomes, and to further perform the statistical analysis within one system.

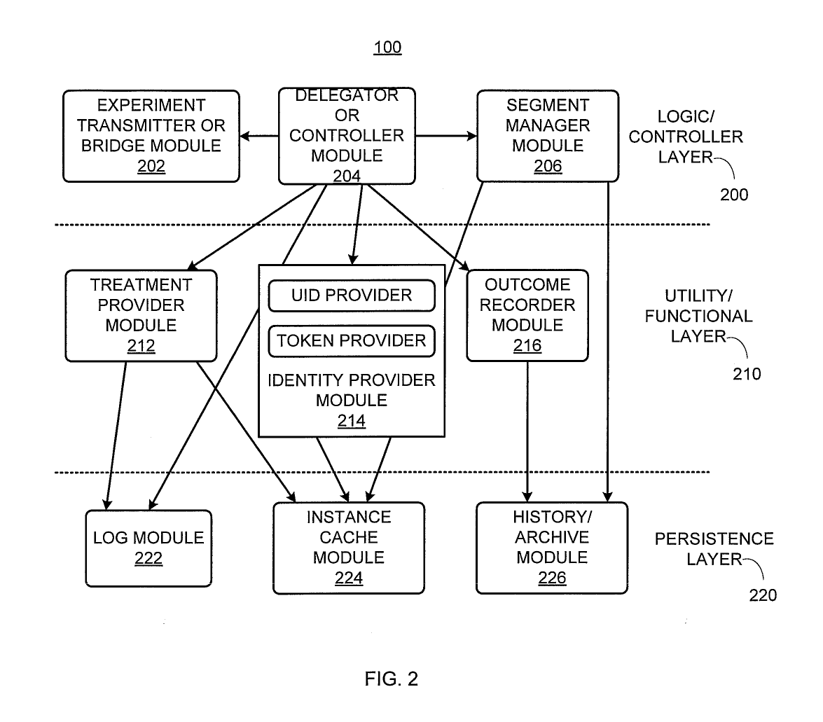

FIG. 2 illustrates MVT BPM optimization system 100 in more detail. MVT BPM optimization system 100 may be partitioned into three layers, namely logic/controller layer 200 (hereinafter ‘logic layer 200’), utility/functional layer 210 (hereinafter ‘utility layer 210’), and persistence layer 220, with each layer including three services. For purposes of facilitating the description, layers 200, 210 and 220 define a conceptual architecture including a single service, or a combination of two or more services. Layers 200, 210 and 220 also describe the general functionality of the respective services illustrated in FIG. 2. A service represents the smallest set of functional operations that a program or programmatic component delivers. Thus a service may be implemented in software, hardware or a combination thereof. In an example, a service may be a physically independent software program with specific design characteristics that support the attainment of the strategic goals associated with service-oriented computing. Each service may be assigned its own distinct functional context and include a set of capabilities related to this context. Those capabilities suitable for invocation by external consumer programs may be expressed via a published service contract (much like a traditional API). A module may be implemented in software, hardware or a combination thereof, and provide the functionality for one or more services. Thus the layers and services of MVT BPM optimization system 100 as shown in FIGS. 1 and 2 are provided for illustrative purposes only and may be partitioned, combined or otherwise modified for facilitating application of MVT BPM optimization system 100 to a user's existing BPM process. Further, the layout of the layers and services as shown in FIGS. 1 and 2 may not be used to structurally or functionally limit the scope of MVT BPM optimization system 100.

A service composition may be a coordinated aggregate of services. A composition of services may thus be comparable to a traditional application in that its functional scope is usually associated with the automation of a parent business process. Thus system 100 may be implemented as a single hardware and software application, or as an aggregation or service composition of individual services as discussed below.

Logic layer 200 includes experiment transmitter or bridge service 202 (hereinafter ‘experiment transmitter service 202’), delegator or controller (page tag) service 204 (hereinafter ‘delegator service 204’), segment manager service 206 and statistical engine service 208. The logic layer may perform orchestration or modify an existing orchestration of an existing BPM system. Utility layer 210 includes treatment provider service 212, UID/token/identity provider service 214 (hereinafter ‘UID (unique identifier) service 214’), and outcome recorder service 216. The utility layer may enable encapsulation of all functional support sub-systems for the BPM optimization system that are used to implement a statistical experiment. If there is any customization or exchange swapping of components in the BPM optimization system, the customization may be isolated to the utility layer. Persistence layer 220 includes log service 222, instance cache service 224, and history/archive service 226 (hereinafter ‘history service 226’). The functionality of each of the foregoing layers and services may be abstractly applied to a user's existing BPM system for BPM optimization.

Experiment transmitter service 202 of logic layer 200 handles all integration with the BPM system. In an example, the experiment transmitter service 202 may be the single point of integration between the BPM optimization system 100 and an existing BPM system that is going to be controlled. Thus with regard to experiment transmitter service 202, depending on a BPM system that is being optimized and its level of automatic or manual functionality, service 202 enables communication and integration between system 100 and an existing BPM system. Delegator service 204 determines which MVT BPM account, experiment and input variables an individual “request” is associated with. In an example, BPM optimization system 100 may be used at a corporation to run several simultaneous experiments by different departments on different systems, such as ERP, BPM etc. A user may first set up an experiment by defining attributes and levels to be used for the experiment, and also define segmentation and outcome variables that will be recorded by system 100. The Delegator service 204 determines which BPM optimization system configuration that the user set up should be accessed. Segment manager service 206 is responsible for all logic and functionality that takes available data and uses it to create a user segmentation context. The interface may be generalized enough to be usable for either MVT or “behavior targeting”. For MVT BPM optimization system 100, segment manager service 206 provides the logic necessary to pair a user with an experimental rule, with the experimental rule being a rule based on segment information that determines whether or not a certain batch of treatments is applied to an experiment. Thus an example of an experimental rule for the foregoing mortgage application example may include a determination of whether an application was initially submitted using a web interface, and based on segmentation data, such an application would be removed or not enrolled in the experiment. Statistical engine service 208 provides the necessary statistical calculations and analysis discussed herein.

Treatment provider service 212 of utility layer 210 creates a randomized experimental treatment based on a particular experimental rule. Treatment provider service 212 has thus been initialized by an experimental design and handles randomization of experimental assignments. Treatment provider service 212 may issue treatments based on full factorial (e.g. all possible combinations) or fractional factorial (e.g. a reduced subset of combinations) designs. The experimental treatment can thus be the optional swapping of one component of MVT BPM optimization system 100 with another component, or with a rules engine that has a specific set of rules. UID provider service 214 handles the generation of a unique identifier and/or a “token”. For various SOA compositions, other services may be designed to work with either a unique identifier or a token. The UID provider service 214 enables creation of a mechanism for associating segmentation data, the assigned treatment, and all outcomes to an individual experimental test subject. For example, during a loan application process in the foregoing mortgage application example, the UID provider service 214 may simply be the loan number. For example, as long as this same loan number is available at the start of an experiment, as long as all customer segmentation (demographic) information can be linked to this loan number, and as long as all future outcome data can be linked to this loan number, the UID provider may simply provide knowledge of how to extract and give the BPM optimization system 100 the loan number. If a unique loan number is not already available, the UID provider service 214 may be a random-number generator that outputs guaranteed unique numbers that all the storage systems can use as a reference key. In some applications, the UID provider service 214 may be part of a composite “token” that encodes the UID reference key with additional information. For example, in the mortgage application example, a system may use high-strength encryption to encode a loan application number along with the applicant's social security number (SSN) and the name of the BPM subsystem. The BPM optimization system 100 may use this token as a convenient mechanism for creating a composite token that helps integrate data from a variety of systems.

Outcome recorder service 216 of utility layer 210 may send outcomes to a persistence system. Outcome recorder service 216 may not necessarily function in real-time, and some outcome data may be captured in a log that is later available to be paired with the rest of the system for modeling, with such data being unavailable for filtered segments.

Log service 222 of persistence layer 220 is a generalized service interface for recording any type of event that would be used for experiment or system-health monitoring. Log service 222 enables individual operations to be recorded to a local file but more important events such as errors or system failures to be delivered via a real-time messaging protocol. Instance cache service 224 provides for storing data (filtered segments, identity, assigned rules or sub-sampling exclusions) for availability for use by services other than a statistical analysis service. History service 226 stores outcome data. This is abstracted as an interface so that it may be readily exchanged with a “CloudDB” or an external system such as OMNITURE or GOOGLE ANALYTICS etc.

With regard to the data in instance cache service 224 and history service 226, as an example, for an experimental subject (e.g. a mortgage applicant who wants a loan) there may be three distinct sets of information. The first set of information may include demographic or segmentation information that describes the experimental subject. This may include all the potentially useful information that is known before the experiment begins. The second set of information may include the experimental treatment (the attributes and their randomly-assigned levels) that determines what experimental parameters will be applied to the experimental subject. The third set of information may include the outcome of the experiment. While an experiment is running and applicants are first getting registered, the BPM optimization system may intake segmentation data (e.g. the first set of information) as inputs and provide experimental treatments (e.g. the second set of information) as outputs. While the experiment is being run, observations (e.g. the third set of information) may be made and recorded. During post-experiment analysis, both the segmentation variables and the experimental treatment/attributes may be accounted for to determine any affect on the outcomes. The segmentation allows determination of whether certain criteria are important in determining which optimal treatment should be applied. For example, it may be determined that of all the mortgage applicants, the new proposed process optimization is optimal for people of a certain background, but does not help for people of a different background. A functional distinction between segmentation data and outcome data is that the former may be (pending optimization analysis) needed as an input when implementing the optimal design at the end of the experiment. That is, it may be used by the delegator service 204, and as such, its implementation may have an immediate access, high availability, caching technology requirement that the outcome data store does not have. In an example, data in instance cache service 224 may have a virtually instant-availability availability by the run-time system, and may include the UID, segmentation/demographic information, and the assigned treatment. The history service 226 may provide for data related to a BPM process at a future time (e.g. years after an initial experiment was run (after mortgage applications were randomized) data related to loan default may still be collected). Thus with regard to the data in instance cache service 224, this data allows for immediate retrieval during the processing of an experiment for example.

The foregoing breakdown of MVT BPM optimization system 100 thus enables application of system 100 to a user's existing BPM process. For example, the foregoing breakdown enables efficient exchange of a particular service or functionality of system 100 with another software package of a user's BPM process (e.g. SAS Software, CLOUD etc.), and thus efficient adaptation of system 100 with a user's BPM process.

For example, an existing BPM process may include a rules engine that is in the form of a logical algorithm that takes a look at some data that has been gathered already by the BPM process, and based on the data the rules engine makes a decision as to another step in the BPM process. For such a rules engine in an existing BPM process, the rules engine may be provided with a MVT BPM optimization adapter that indicates that based on one of the particular attributes in an experiment, to use a rules algorithm A vs. rules algorithm B vs. rules algorithm C to decide what decision a BPM orchestration engine needs to make in terms of its process flow. Parts of the existing BPM process would then be attached to MVT BPM optimization system 100 for recording information that has been collected along the process for providing information about a customer or entity the BPM process was associated with, and for determining which experimental treatment was being delivered. During this process, for performing statistical experimentation, an experimental treatment would first be assigned, and thereafter, a metric that is being optimized would be recorded. MVT BPM optimization system 100 would thus be added to an existing BPM process for storing and recording data that would be used at a final stage of modeling.

MVT BPM optimization system 100 also includes an adaptive process that allows for flagging of certain treatments as suboptimal while an experiment is running (e.g. prior to completion of an experiment). Thus system 100 can adapt itself in real-time so that it decreases the number of times suboptimal experiments are allowed to continue to process. This allows for realization of gains and mitigation of losses in an expedited manner. Thus if an experiment is set with the assumption that a certain change would provide improvements to a process, if that change is put in place but does not yield an improvement, system 100 would rapidly indicate whether the change is a suboptimal change.

MVT statistical experiments performed via MVT BPM optimization system 100 allow for determination of statistical significance and separation of each one of the different segments and attributes of an experiment from each other. Thus for a multi-step process, a statistical estimate as to which one of the attributes contributed more or less to the ultimate improvement are determined and which of the attributes have no measurable effects are ascertained. Statistical estimates with confidence intervals as to what each one of the levels had as an improvement are also determined. Additionally, when using standard MVT statistical processes, the interaction between two processes are also determined. For example, the interaction between a processing step added at the beginning of a BPM process is determined with a different processing step added at another location in the BPM process. In an example, the interactions may be based on interactions between different attributes, different segments, or between attributes and segments, with attributes relating to aspects of an experiment that can be readily controlled and segments relating to aspects that can be controlled but are generally properties that are not controlled independently.

### 3. Method

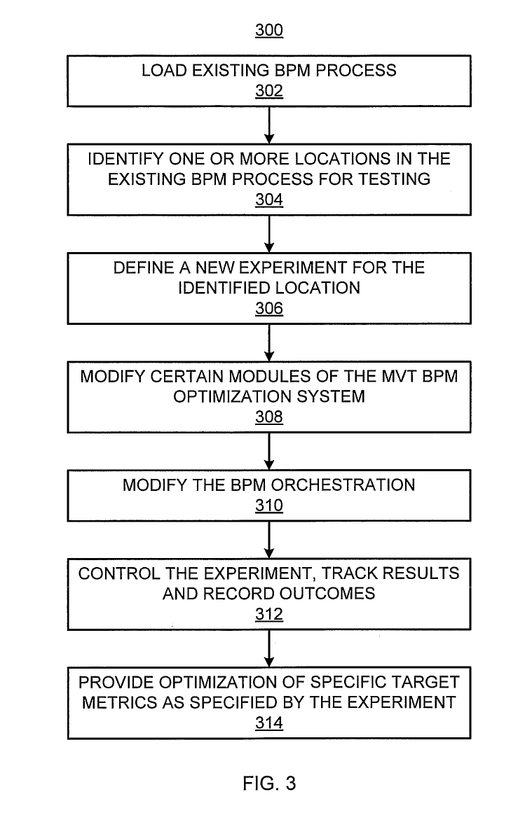

FIG. 3 illustrates a flowchart of a method 300 for performing a MVT BPM optimization on a BPM process, according to an embodiment. The method 300 may be implemented on MVT BPM optimization system 100 described above referring to FIGS. 1 and 2 by way of example and not limitation. The method 300 may be practiced in other systems.

At step 302, a user (e.g. a business analyst) may load their existing BPM process for further analysis and optimization via MVT BPM optimization system 100.

At step 304, the user may identify one or more locations in the existing BPM process for testing. In this regard, the user may create a node in the existing BPM process (e.g. in the BPM flow diagram) driven by MVT BPM optimization system 100 for adding, modifying or removing an existing BPM sub-process.

At step 306, the user may define a new experiment for the identified location or created node, and define its attributes in MVT BPM optimization system 100. With the experiment and attributes defined, MVT BPM optimization system 100 may be part of the user's existing BPM orchestration.

At step 308, the user may modify certain services (e.g. services for logic layer 200, utility layer 210, or persistence layer 220) of the MVT BPM optimization system 100 to tailor system 100 to the existing BPM process. For example, the breakdown of MVT BPM optimization system 100 in layers and services enables efficient exchange of a particular service of system 100 with another software package of a user's BPM process (e.g. SAS Software, CLOUD etc.), and thus efficient adaptation of system 100 with a user's BPM process. The functionality of each of the foregoing layers and services would thus be abstractly applied to a user's existing BPM process for BPM optimization.

At step 310, with the experiment defined at step 306, the BPM orchestration would be modified by adding a new service associated with a particular attribute of the experiment, and based on the level of that attribute, the flow of the modified BPM process may be directed to one or more new or different paths of the overall BPM process (e.g. overall BPM flow diagram). MVT BPM optimization system 100 thus provides a platform that allows a user (e.g. a business analyst) to define an experiment to actually control the existing BPM process in order to create variations and track their outcomes, and to further perform the statistical analysis within one system.

At step 312, MVT BPM optimization system 100 uses the software for the existing BPM process (orchestration and rules engines) to control an experiment, track results and record outcomes, and uses statistical practices to drive the entire process.

At step 314, MVT BPM optimization system 100 provides optimization of specific target metrics as specified by the experiment(s) in step 306, and thus optimization of a user's existing BPM process.

### 4. Example

Examples of applications of MVT BPM optimization system 100 will be described herein with reference to automation of a home mortgage application review and approval process.

Briefly, in a home mortgage application review and approval process, a mortgage application may first be entered by either web page entry, direct entry by a loan officer in an internal computer system, or data entry done from a paper form mailed to a processing center. Upon receipt of an application by one of these processes, the data may be reviewed and further clarification may be requested if some of the entries are erroneous. After retrieval of an applicant's credit history, the application may be reviewed, and a determination would be made (for example if the credit score is sufficiently low) if additional supporting documentation should be required of the applicant. Thereafter, the offered interest rate and terms may be calculated, with more favorable terms being offered to most credit-worthy applicants. After submission of the application to an underwriter for review and approval, if the underwriter needs more documentation, the applicant would be contacted, and upon request and receipt of the documentation, the documentation would be sent to the underwriter. Finally, the application would be sent for decision, and upon approval, the next step would be to get the applicant to accept terms and schedule closing. This process may involve a large number of computer systems, some of them external to the bank (e.g. retrieving credit history from a rating agency). Thus in this case, the home mortgage application BPM “orchestrates” all of the necessary systems and human agents to facilitate the processing of mortgage applications.

An example of an application of MVT BPM optimization system 100 for the foregoing mortgage application process may include determination of an optimal credit score at which a certain path should be taken in the BPM process. For example, a rules engine in a BPM process may state that for a credit score of less than 500, an applicant is automatically disqualified. A BPM experiment may be performed using MVT BPM optimization system 100 on this rules engine to determine an optimal level for the attribute of a credit score at which to disqualify an individual (e.g. perhaps the optimal disqualification score should be less than 520 instead of 500). The result of such an experiment would specify a credit score at which it would be optimal to automatically disqualify an individual. Additionally, an experiment may define an applicant's level of education as a segment. During the data analysis, statistical methodology can be used to determine whether the optimal disqualification point differs between applicants with or without a college diploma. In an example, other factors such as previous homeownership or age may be simultaneously analyzed.

In an example of segmentation, several loan officers may be known to have completed a training course teaching critical computer skills. A segmentation variable may be defined that captures whether a loan officer had received the training in the past. Post-experiment analysis may determine whether the employee training had an impact on application accuracy. That impact may or may not have an interaction with the length of the loan officer's tenure, all of which may assist with design of an optimal BPM system.

In another example of an application of MVT BPM optimization system 100 for the foregoing mortgage application process, assume a mortgage application has been completed by entering either (A) web page entry, (B) direct entry by a loan officer in an internal computer system, or (C) data entry done from a paper form mailed to a processing center. For option (C), an existing BPM process includes additional checks to determine if a mortgage application is complete. If it has been determined that for option (B), junior loan officers have had problems submitting applications, with MVT BPM optimization system 100 an attribute can be set such that if a loan officer has less than four months of experience, the application would be sent through the process for option (C), where the existing BPM process includes additional checks to determine if a mortgage application is complete. Thus an MVT BPM optimization system node may be placed at the process that normally went from a loan officer submission (option (B)) to the process of submission via a mail center (option (C)) that includes additional checks to determine if a mortgage application is complete. Based on this experiment via MVT BPM optimization system 100, system 100 can statistically determine if the modification to the existing BPM process is beneficial. In this manner, multiple outcome metrics can be tested (e.g. how fast rejection/approval gets to a customer, or number of applicants that end up getting approved etc.), with the foregoing being an example of how an existing BPM process can be changed via MVT BPM optimization system 100.

### 5. Computer System

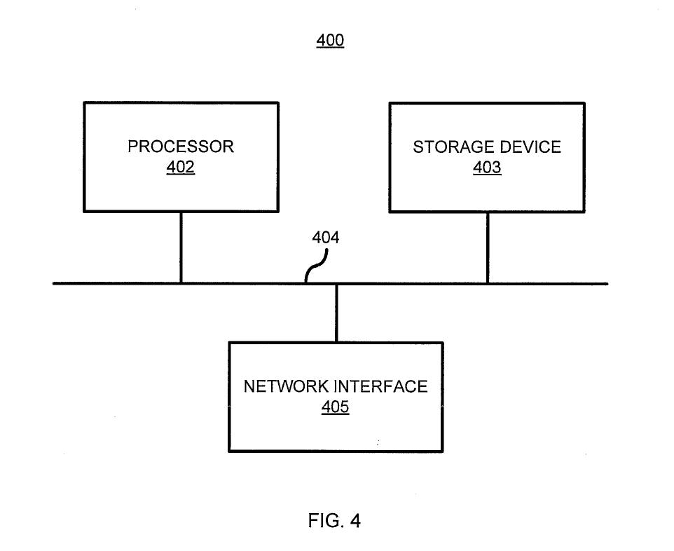

FIG. 4 shows a computer system 400 that may be used as a hardware platform for MVT BPM optimization system 100. Computer system 400 may be used as a platform for executing one or more of the steps, methods, modules, services and functions described herein that may be embodied as software stored on one or more computer readable mediums. The computer readable mediums may be non-transitory, such as storage devices including hardware.

Computer system 400 includes a processor 402 or processing circuitry that may implement or execute software instructions performing some or all of the methods, modules, services, functions and other steps described herein. Commands and data from processor 402 are communicated over a communication bus 404. Computer system 400 also includes a computer readable storage device 403, such as random access memory (RAM), where the software and data for processor 402 may reside during runtime. Storage device 403 may also include non-volatile data storage. Computer system 400 may include a network interface 405 for connecting to a network. It will be apparent to one of ordinary skill in the art that other known electronic components may be added or substituted in computer system 400.

While the embodiments have been described with reference to examples, those skilled in the art will be able to make various modifications to the described embodiments without departing from the scope of the claimed embodiments.

What is claimed is:

1. A multivariate business process modeling or management (BPM) optimization system to optimize a BPM system, the BPM optimization system comprising:
a logic layer to control operation of the BPM system;
a utility layer including software executed by a computer system to implement a randomized experimental treatment based on a hypothesis; and
a persistence layer to collect data from application of the randomized experimental treatment to the BPM system,
wherein the multivariate BPM optimization system optimizes the BPM system by computerized testing of the hypothesis and generation of results to add, remove or modify a step or modify a point in a flow of the BPM system based on the data collected from application of the randomized experimental treatment.

2. The multivariate BPM optimization system of claim 1, wherein the logic layer includes:
an experiment transmitter service to integrate the BPM optimization system with the BPM system or a BPM sub-system;
a delegator service to associate the BPM system or the BPM sub-system with an experimental treatment in the BPM optimization system; and
a segment manager service to define experimental segments based on the data collected from application of the randomized experimental treatment.

3. The multivariate BPM optimization system of claim 1, wherein the utility layer includes:
a treatment provider service to create the randomized experimental treatment based on a particular attribute;
an identity provider service to manage reference keys used by an instance cache service, a history archive service, or external BPM data systems to uniquely identify experimental test subjects; and
an outcome recorder service to manage delivery and storage of experimental outcomes.

4. The multivariate BPM optimization system of claim 1, wherein the persistence layer includes:
a log service to record events associated with the BPM system;
an instance cache service to store treatment, identity and segmentation data accessibility; and
a history service to store the data collected from application of the randomized experimental treatment.

5. The multivariate BPM optimization system of claim 1, wherein the logic, utility and persistence layers enable customization and adaptation of the multivariate BPM optimization system to the BPM system.

6. The multivariate BPM optimization system of claim 1, wherein the randomized experimental treatment includes an assignment of levels of attributes in a statistical experimental design.

7. The multivariate BPM optimization system of claim 1, wherein the randomized experimental treatment includes a variation in a process in the BPM system.

8. The multivariate BPM optimization system of claim 1, further comprising an adaptive process to indicate if the randomized experimental treatment is suboptimal prior to completion of a statistical experiment.

9. The multivariate BPM optimization system of claim 1, wherein the results are automatically generated statistically significant results for gain and loss predictions based on modification of the BPM system.

10. The multivariate BPM optimization system of claim 1, wherein the results are automatically generated statistically significant results for determination of significance of contribution of a particular attribute of the randomized experimental treatment.

11. The multivariate BPM optimization system of claim 1, wherein the results are automatically generated statistically significant results for determination of an interaction between different processes of an optimized BPM system or the BPM system.

12. A method for optimizing a business process modeling or management (BPM) system, the method comprising:
identifying a location in the BPM system to test;
defining a randomized experimental treatment based on a hypothesis for the identified location, and applying the randomized experimental treatment to the BPM system;
optimizing the BPM system by computerized testing of the hypothesis and generating results; and
adding, removing or modifying a step or modifying a point in a flow of the BPM system based on data collected from application of the randomized experimental treatment.

13. The method of claim 12, further comprising defining attributes of the randomized experimental treatment and assigning levels of the attributes in a statistical experimental design.

14. The method of claim 12, further comprising modifying a process or relative flow of a process in the BPM system for the randomized experimental treatment.

15. The method of claim 12, further comprising automatically indicating if a randomized experimental treatment is suboptimal prior to completion of a statistical experiment.

16. The method of claim 12, wherein the results are automatically generated statistically significant results for determining significance of contribution of a particular attribute of the randomized experimental treatment.

17. The method of claim 12, wherein the results are automatically generated statistically significant results for determining an interaction between different processes of an optimized BPM system or the BPM system.

18. A non-transitory computer readable medium having stored thereon a computer executable program to optimize a business process modeling or management (BPM) system, the computer executable program when executed causes a computer system to:
identify a location in the BPM system to test;
define a randomized experimental treatment based on a hypothesis for the identified location, and apply the randomized experimental treatment to the BPM system;
optimize the BPM system by testing the hypothesis and generating results; and
add, remove or modify a step or modify a point in a flow of the BPM system based on data collected from application of the randomized experimental treatment.

19. The computer readable medium of claim 18, further comprising defining attributes of the randomized experimental treatment and assigning levels of the attributes in a statistical experimental design.

20. The computer readable medium of claim 18, further comprising varying a process or relative flow of a process in the BPM system for the randomized experimental treatment.
